(19) United States
(12) Patent Application Publication
(10) Pub. No.: US 2017/0249146 A1
(43) Pub. Date: Aug. 31, 2017

(54) BANDWIDTH REDUCTION FOR INSTRUCTION TRACING

(71) Applicant: QUALCOMM Incorporated, San Diego, CA (US)

(72) Inventors: Suresh Kumar VENKUMAHANTI, Austin, TX (US); Venkatarami MORA, San Diego, CA (US)

(21) Appl. No.: 15/057,111

(22) Filed: Feb. 29, 2016

(51) Int. Cl. G06F 9/30

(52) U.S. Cl. CPC G06F 9/30043; G06F 9/3005

(57) ABSTRACT

Systems and methods pertain to reducing bandwidth of instruction tracing for a processor, using an Embedded Trace Macrocell (ETM). Packets, which include trace information for load/store instructions executed in the processor, are generated. A P-Header comprising commit information for load/store instructions of up to a maximum number of two or more packets is generated. The P-Header is generated for the maximum number of two or more packets if none of the load/store instructions in the maximum number of two or more packets were killed. If a load/store instruction in a packet was killed, a P-Header comprising commit information for the packet comprising the load/store instruction which was killed is generated and placed in an instruction trace immediately after that packet, even if the maximum number is not reached.

### FIELD OF DISCLOSURE

Disclosed aspects pertain to debugging mechanisms including instruction tracing in processing systems. More particularly, exemplary aspects are directed to bandwidth reduction of instruction tracing using Embedded Trace Macrocell (ETM) mechanisms.

### BACKGROUND

Modern processors may employ tracing mechanisms that allow real-time debugging capabilities. For example, tracing mechanisms such as an Embedded Trace Macrocell (ETM), as known in the art, can enable debugging of software executing on a processor, for example, by capturing in real-time, detailed information about the software's execution flow. The ETM can non-intrusively monitor and record select code or execution information, to capture information regarding the processor's state, for example, before and after a specific event. The ETM can then generate packets comprising the execution information, and send out a trace sequence comprising a stream of packets to a memory known as an embedded trace buffer (ETB), which can be located on the same chip as the processor (on-chip) or outside the chip on which the processor is integrated (off-chip). The ETB, which comprises a repository of the trace sequence, can provide the trace sequence to a debug host or a decompressor, which can reconstruct the execution flow based on the trace sequence. The reconstruction of the execution can provide a debugger or user with direct visibility of the software's runtime behavior.

A dedicated trace port may be provided in the ETM to allow the trace information to be transferred to the decompressor without interrupting the processor. Accordingly, the processor can continue to execute instructions without being stalled by the ETM. In some cases, the packets generated by the ETM may include real-time addresses for load and store instructions (e.g., encountered in software or programs executed by the processor). The decompressor may be configured to receive the packets and correlate the addresses to the corresponding load/store instructions in the course of debug operations. The packets comprising the load/store addresses, as well as information related to the corresponding load/store can involve large amounts of data. Correspondingly, the trace port may be designed to be large enough to support the high bandwidth for sending the large amounts of data to the decompressor. Accordingly, there is an increased cost for resources to support the large amounts of data to be transferred (e.g., large trace port widths, large number of wires to transfer high bandwidth information, etc.,) which also leads to increased power consumption.

Thus, to keep costs low and reduce power consumption, there is a need to reduce the amount of information transferred by the ETM to the external debug hosts such as the decompressor.

### SUMMARY

Exemplary aspects of the invention are directed to Systems and methods pertain to reducing bandwidth of instruction tracing for a processor, using an Embedded Trace Macrocell (ETM). Packets, which include trace information for load/store instructions executed in the processor, are generated. A P-Header comprising commit information for load/store instructions of up to a maximum number of two or more packets is generated. More specifically, a P-Header comprising commit information for load/store instructions of a maximum number of two or more packets is generated if none of the load/store instructions in the two or more packets were killed. If a load/store instruction in a packet was killed, a P-Header comprising commit information for the packet comprising the load/store instruction which was killed is generated, and placed in an instruction trace immediately after that packet.

For example, an exemplary aspect is directed to a method of instruction tracing, the method comprising generating packets comprising trace information for load/store instructions executed in a processor, and generating a P-Header comprising commit information for load/store instructions of a maximum number of two or more packets, if none of the load/store instructions in the maximum number of two or more packets were killed.

Another exemplary aspect is directed to an apparatus comprising a packet generator configured to generate packets comprising trace information for load/store instructions executed in a processor, and a P-Header generator configured to generate a P-Header comprising commit information for load/store instructions of a maximum number of two or more packets, if none of the load/store instructions in the maximum number of two or more packets were killed.

Yet another exemplary aspect is directed to an apparatus comprising means for generating packets comprising trace information for load/store instructions executed in a processor, and means for generating a P-Header comprising commit information for load/store instructions of a maximum number of two or more packets if none of the load/store instructions in the maximum number of two or more packets were killed.

### BRIEF DESCRIPTION OF THE DRAWINGS

The accompanying drawings are presented to aid in the description of aspects of the invention and are provided solely for illustration of the aspects and not limitation thereof.

FIG. 1 illustrates a processing system configured according to exemplary aspects.

FIG. 2 illustrates a packet generator for an Embedded Trace Macrocell (ETM) configured according to exemplary aspects.

FIG. 3 illustrates a flow-chart for a method of instruction tracing, according to exemplary aspects.

FIG. 4 illustrates a computing device in which an aspect of the disclosure may be advantageously employed.

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Exemplary aspects of this disclosure pertain to reducing the amount of information sent by an ETM of a processor to an external trace analyzer or decompressor, e.g., through a trace port. In general, ETM protocols include trace elements called packets (alternatively referred to as “atoms”), which comprise information pertaining to instructions, addresses, etc., as previously described. A P-Header, as known in the art, is a compressed packet which can include a header but no data (also referred to as “payload”). In general, a P-Header can include information pertaining to instructions in a preceding packet, e.g., whether the instructions executed, committed, were killed, etc. Conventionally, a P-Header is placed after each packet when a trace comprising a sequence of packets is generated by the ETM and sent out to the decompressor, so that the decompressor can correlate the information in a P-Header to the instructions in the preceding packet. For example, if a packet comprises one or more load/store instructions, then a P-Header for the packet is conventionally placed immediately following the packet in a trace sequence sent out to the decompressor, so that the debugger can determine information, such as whether the load/store instructions in the packet committed from the P-Header.

However, this conventional manner of placing a P-Header after each packet may lead to an unnecessary increase in the bandwidth of trace information provided by the ETM to the debugger. It is recognized that the format of a P-Header allows for including commit information for two or more packets (in some examples, a P-Header can hold commit information for up to a pre-specified maximum number, such as, 18 packets). Accordingly, in exemplary aspects, a P-Header is not automatically placed following each and every packet in a trace sequence generated by an exemplary ETM. Rather, a trace sequence of a maximum number of packets (e.g., 18 packets in the aforementioned example) is allowed to be generated by the exemplary ETM, following which a single P-Header is placed. For example, a single P-Header packet can be generated and placed in a trace sequence after the maximum number of packets are generated, wherein the P-Header holds information (e.g., commit information) for the maximum number of packets in the trace sequence.

Exemplary aspects of generating a single P-Header for a maximum number of two or more packets (wherein each packet comprises one or more load/store instructions) may generally be applicable except in cases where a load/store instruction in a packet is killed (e.g., based on a predicate load/store kill). If a load/store instruction in a particular packet is killed, then a P-Header is generated immediately following the particular packet in which the load/store kill occurred, even if the maximum number of packets in a trace sequence is not reached.

An exemplary decompressor is configured to receive exemplary trace sequences comprising a single P-Header for up to a maximum number of two or more packets and correlate information (e.g., commit information) provided by the single P-Header packet to corresponding packets of up to the maximum number of two or more packets in the trace sequence. In this manner, the amount of trace information, and corresponding resource and bandwidth utilization, power consumption, etc., can be reduced in exemplary aspects.

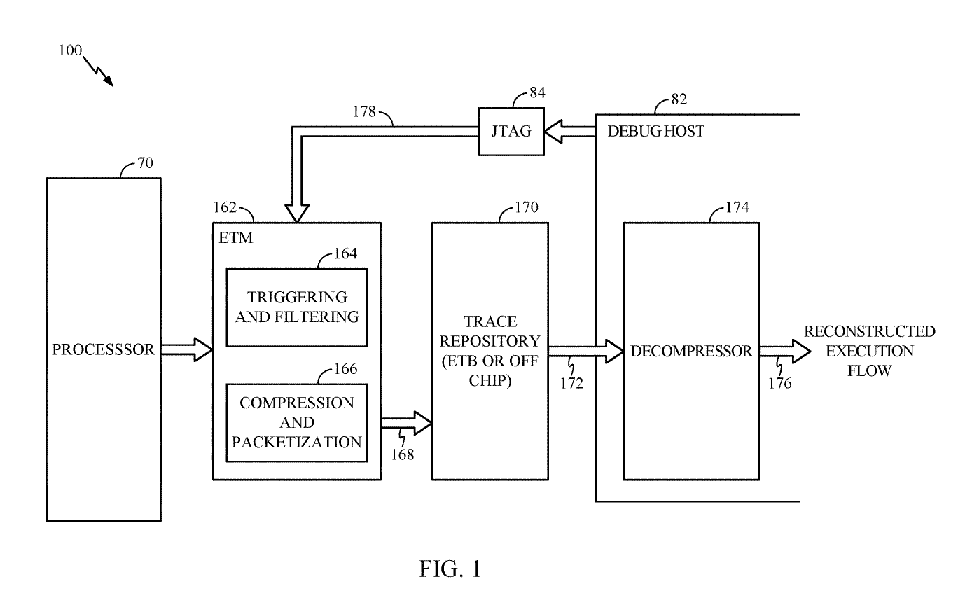

With reference now to FIG. 1, processing system 100 configured with real-time debug capabilities will be described, by way of background. As an overview of FIG. 1, processing system 100 includes processor 70, which interfaces Embedded Trace Macrocell (ETM) 162. ETM 162 includes two blocks shown as triggering and filtering block 164, and compression and packetization block 166. ETM 162 provides output 168 to trace repository 170. Trace repository 170 may include, for example, an embedded trace buffer (ETB) circuit or an off-chip circuit. From trace repository 170, trace information is provided on output 172 to debug host 82. Debug host 82 comprises decompressor 174 for receiving output 172 and generating reconstructed execution flow 176. ETM 162 receives control input 178 from the interface shown as Joint Test Action Group (JTAG) 84. A JTAG such as JTAG 84, as known in the art, specifies standard implementations of interfaces which connect to on-chip test access points (TAP). In FIG. 1, JTAG 84 generates control input 178 for ETM 162 in response to data and instructions from debug host 82.

Further details of the above components of FIG. 1 will now be discussed. Processor 70 may be any general or special purpose processor (e.g., a digital signal processor or “DSP”) which may implement an instruction pipeline for executing instructions. ETM 162 may monitor and trace execution information as the instructions are executed in processor 70. Specifically, triggering and filtering block 164 can comprise a circuit or logic block which can control the information which is recorded by ETM 162. Trigger conditions on which ETM tracing can be turned on can include detection of certain instruction addresses (or program counter (PC) values). For example, tracing may be performed when load/store instruction addresses are detected. Tracing information which is not deemed relevant or important can also be filtered out. The trigger conditions and filtering operations can be programmable, for example, via JTAG 84.

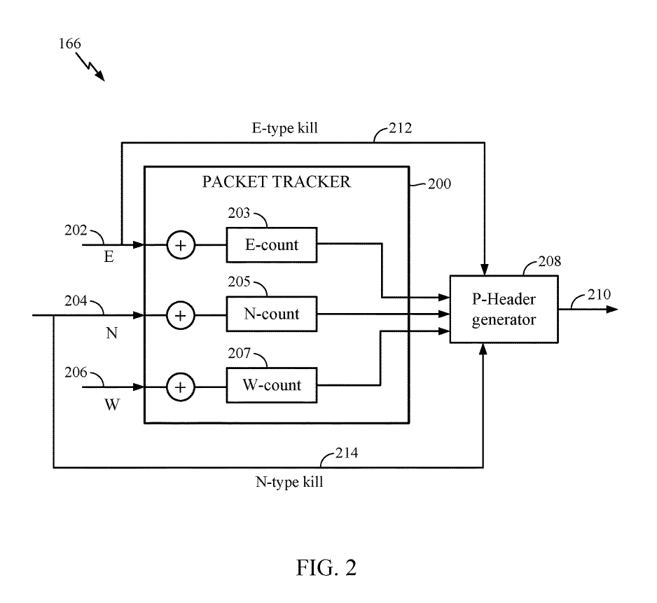

Compression and packetization block 166 can include a packet generator, configured to receive execution information traced by ETM 162 and assemble the execution information for generating packets. The packets generated by compression and packetization block 166 can be sent out of ETM 162 through output 168. Output 168 may be provided to trace repository 170. Compression and packetization block 166 can generate P-Header packets according to exemplary aspects of this disclosure, as will be further described with reference to FIG. 2.

With continuing reference to FIG. 1, depending on whether trace repository 170 is implemented on-chip or off-chip, output 168 or output 172 of trace repository 170 may pass through a trace port (not shown). A trace port may comprise an interface or port from the chip or semiconductor die on which processor 70 and ETM 162 are integrated, to an external analyzer such as decompressor 174. In an on-chip implementation, trace repository 170 may include an on-chip ETB. An on-chip ETB can provide on-chip memory area where trace information can be stored during capture (e.g., real-time), rather than being exported immediately through the trace port. The information stored in the on-chip ETB can be read out at a reduced clock rate on output 172, for example, once capture has been completed. In this implementation, output 172 may pass through the trace port to be provided to debug host 82 implemented off-chip. On the other hand, if trace repository 170 is located off-chip, then output 168 may pass through the trace port to be provided to the off-chip trace repository 170. In other words, either output 168 or output 172 may pass through a trace port depending on particular implementations. In any event, the amount of data passing through the trace port, or the bandwidth of output 168/172 can be reduced in exemplary aspects of this disclosure, based at least in part on exemplary aspects of P-Header generation by compression and packetization block 166 (as will be discussed with reference to FIG. 2, below).

Trace repository 170 may provide output 172 comprising trace information (e.g., at a suitable bandwidth depending on whether trace repository 170 is on-chip or off-chip) to decompressor 174. Decompressor 174 may be a component of debug host 82, configured to accept output 172 and reconstruct the flow of instructions which took place in processor 70. Decompressor 174 may be implemented using a suitable combination of hardware and software. Reconstructed execution flow 176 can provide detailed visibility into the instruction pipeline of processor 70. In exemplary aspects, decompressor 174 may be configured to receive exemplary P-Headers comprising information related to two or more packets and generate reconstructed execution flow 176 for the two or more packets.

With reference now to FIG. 2, further details of compression and packetization block 166 of FIG. 1 are illustrated. In exemplary aspects, P-Header generator 208 of compression and packetization block 166 is configured to generate a single header packet known as the “P-Header” for up to a maximum number of two or more packets comprising trace information, under certain conditions. Each packet of up to the maximum number of two or more packets can include trace information such as one or more load/store instructions and their corresponding PC values or addresses. When a single P-Header packet is generated for up to the maximum number of two or more packets (e.g., where the maximum number is 18 packets in some cases), the amount of information transferred on outputs 168/172 (see FIG. 1) is reduced, leading to a reduction in bandwidth.

A P-Header configuration will now be described in more detail. A P-Header includes information regarding at least one packet. P-Header generator 208 can be configured with different rules, which may be implementation specific, for generating a P-Header. The packets represented by a P-Header can be of different types. In general, E-type and N-type packets correspond to packets comprising at least one load/store instruction, while W-type packets indicate wait cycles in which no instructions were executed.

More specifically, an E-type packet, designated by the reference numeral 202 in FIG. 2, is formed for a packet which includes a branch instruction, if the branch instruction was taken. An N-type packet, designated by the reference numeral 204 in FIG. 2 is formed for a packet which includes a branch instruction, if the branch-instruction was not-taken. If a packet does not have a branch instruction, then an E-type packet 202 can be formed, which indicates that the non-branch instruction was processed (without regard to taken/not-taken designations). In this disclosure, each E-type packet 202 and each N-type packet 204 is assumed to include at least one load/store instruction (wherein the load/store instruction in a packet may be based on a branch instruction, or the load/store instruction may be separate from a branch instruction in a packet). As previously mentioned, a W-type packet, designated by the reference numeral 206 in FIG. 2, can indicate wait cycles in which no instructions were executed in the instruction pipeline of processor 70.

In a cycle-accurate mode, ETM 162 of FIG. 1 may record instruction behavior for each clock cycle. In a non-cycle-accurate mode, clock cycles are not taken into account when recording instruction behavior. Thus, in a non-cycle-accurate mode, W-type packets 206 may not be considered when generating P-Headers. In both cycle-accurate and non-cycle-accurate modes, E-type packets 202 and N-type packets 204 may be considered in generating P-Headers.

As shown in FIG. 2, compression and packetization block 166 includes packet tracker 200 to track E-type packets 202, N-type packets 204, and where relevant (e.g., in a cycle-accurate mode), W-type packets 206. A count of E-type packets 202 is maintained in E-count 203; as each E-type packet 202 is received, the count of the number of E-type packets 202 is incremented. Similarly, N-count 205 maintains a count of N-type packets 204 and W-count 207 maintains a count of W-type packets 206.

P-Header generator 208 receives E-count 203, N-count 205, and where relevant, W-count 207. As shown, lines 212, 214 respectively provide indications of whether a corresponding E-type packet 202 or N-type packet includes at least one load/store instruction which was killed. Accordingly, lines 212 and 214 are respectively referred to as E-type kill indication 212 and N-type kill indication 214.

In exemplary aspects, unless E-type kill indication 212 or N-type kill indication 214 is asserted, P-Header generator 208 generates a P-Header on output 210 with information pertaining to a combined number of two or more E-type packets 202 and/or N-type packets 204, wherein the combined number is up to the pre-specified maximum number. The information in the P-Header can include commit information for the load/store instructions in the corresponding E-type packets 202 and/or N-type packets 204, as well as information such as which execution thread the instructions in these packets belongs to, etc.

More specifically, unless E-type kill indication 212 or N-type kill indication 214 is asserted, the combined number or sum of E-count 203 and N-count 205 is allowed to reach the pre-specified maximum number (e.g., 18 in some exemplary P-Header formats) before P-Header generator 208 assembles a P-Header with information in the received E-type packets 202 and/or N-type packets 204. E-count 203 and N-count 205 can be cleared after the maximum number is reached and a P-Header is generated and sent out on output 210 of P-Header generator 208, following which, the count can start over for the next P-Header generation. Output 210 from P-Header generator 208 may be provided along with various other signals and information supplied on output 168 of FIG. 1, to be eventually received by decompressor 174 of FIG. 1. Decompressor 174 can process the P-Header to reconstruct the instruction execution sequence based on information related to E-type packets 202 and N-type packets 204 in the P-Header.

The behavior of P-Header generator 208 for assembling a P-Header with the maximum number of two or more E-type packets 202 and/or N-type packets 204 can be modified if E-type kill indication 212 or N-type kill indication 214 is asserted, as previously mentioned. E-type kill indication 212 or N-type kill indication 214 is asserted, if a corresponding E-type packet 202 or N-type packet 204 includes a load/store instruction which was killed (e.g., a predicate load/store instruction which was killed, or not executed, or did not commit) If E-type kill indication 212 or N-type kill indication 214 is asserted, then P-Header generator 208 immediately generates a P-Header, without waiting for the sum of E-count 203 and N-count 205 to reach the pre-specified maximum number. Thus, in cases where a first packet (e.g., E-type packet 202 or N-type packet 204) comprises a load/store instruction which was killed, a P-Header comprising commit information for the first packet is immediately generated even if the maximum number is not reached, and the P-Header is placed immediately after the first packet in an instruction trace.

Finally, W-count 207 for W-type packets 206 can also be used by P-Header generator 208 in generating the P-Header if information regarding the number of wait cycles is relevant to a particular implementation, but this may not affect the above-described exemplary aspects of P-Header generation for E-type packets 202 and N-type packets 204 based on E-count 203 and N-count 205. For example, in a cycle-accurate mode of ETM 162, W-count 207 may provide information regarding the W-type packets 206 or wait cycles in a particular P-Header. However, even if a number (equal to W-count 207) of W-type packets 206 are included or represented by a particular P-Header, P-Header generator 208 may still generate a P-Header after a sum of E-count 203 and N-count 205 reaches the pre-specified maximum number (unless an E-type kill indication 212 or N-type kill indication 214 is asserted, as described above).

Accordingly, in exemplary aspects, output 210 of P-Header generator 208 can include less than one P-Header generated per packet (e.g., E-type packets 202 or N-type packets 204). This leads to a reduction in the amount of information transmitted in output 210, and correspondingly, bandwidth, power, and costs savings (e.g., in terms of related wires, ports, input/output pins for implementing outputs 168, 172 of FIG. 1).

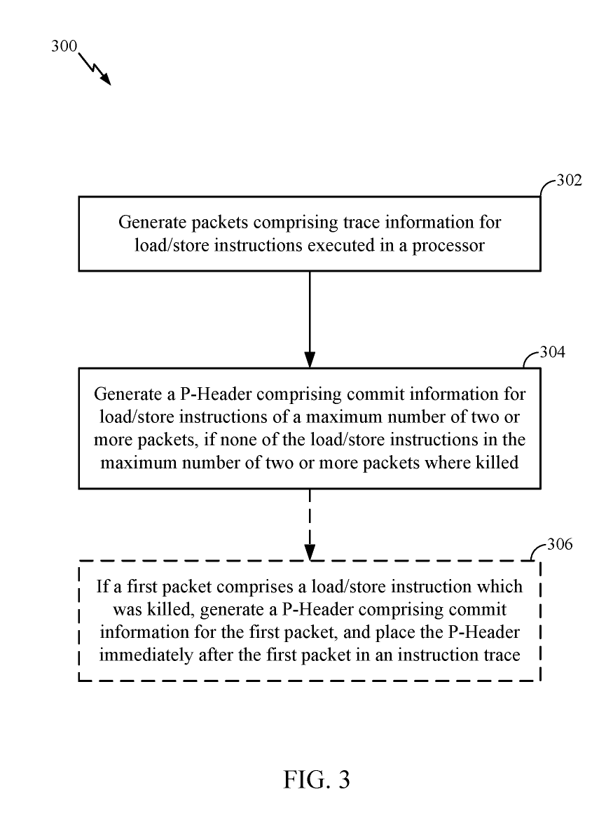

Accordingly, it will be appreciated that exemplary aspects include various methods for performing the processes, functions and/or algorithms disclosed herein. For example, FIG. 3 illustrates method 300 for instruction tracing (e.g., in ETM 162 of FIG. 1).

As shown in Block 302, method 300 comprises: generating packets comprising trace information for load/store instructions executed in a processor. For example, Block 302 pertains to generating packets in compression and packetization block 166 with trace information for load/store instructions executed in processor 70.

In Block 304, method 300 comprises generating a P-Header comprising commit information for load/store instructions of a maximum number of two or more packets, if none the load/store instructions in the maximum number of two or more packets were killed. For example, Block 304 comprises generating, in P-Header generator 208, a P-Header comprising commit information for load/store instructions of up to a maximum number of two or more packets (e.g., E-type packets 202 and/or N-type packets 204). The maximum number of two or more packets are generated as in Block 304, unless an E-type kill indication 212 or N-type kill indication 214 is asserted, in which case, method 300 may enter optional Block 306 discussed below. An E-type packet 202 can comprise a branch instruction which was taken and the N-type packet 304 can comprise a branch instruction which was not-taken. In some cases, the maximum number may be a pre-specified maximum number, such as 18 packets, in exemplary aspects discussed above. In some aspects, the instruction trace is provided to an external trace analyzer or decompressor 174 for reconstructing an instruction execution sequence.

If during instruction tracing by method 300, a first packet (e.g., E-type packet 202 or N-type packet 204) is encountered, wherein the first packet comprises a load/store instruction which was killed, method 300 enters optional Block 306. Block 306 comprises, for example, receiving a kill indication (e.g., E-type kill indication 212 or N-type kill indication 214) that a load/store instruction in the first packet was killed, and generating a P-Header, e.g., in P-Header generator 208, immediately following the first packet, even if the maximum number is not reached, as in the case of Block 304. In Block 306, the P-Header may be placed immediately after the first packet in the instruction trace.

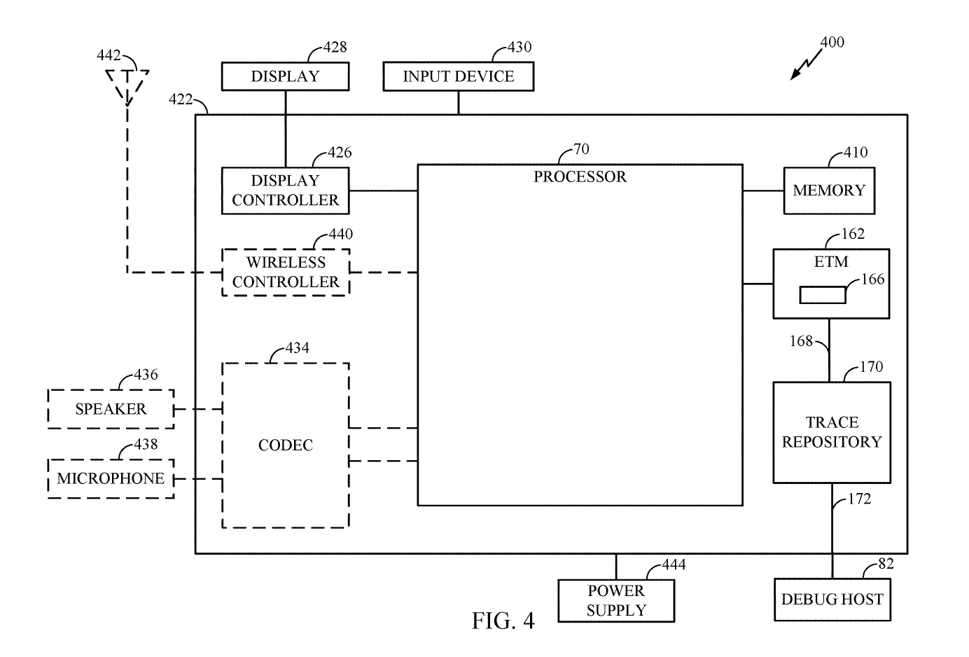

An example apparatus in which exemplary aspects of this disclosure may be utilized, will now be discussed in relation to FIG. 4. FIG. 4 shows a block diagram of computing device 400, which includes processor 70, discussed, for example, with reference to FIG. 1. In some aspects, computing device 400 may be configured as a wireless communication device. FIG. 4 also shows ETM 162 (comprising compression and packetization block 166) coupled to processor 70 and to trace repository 170, wherein trace repository 170 may be coupled to debug host 82, as discussed in FIG. 1. Further details of these components discussed with reference to FIGS. 1 and 2 have been omitted from FIG. 4, for the sake of clarity, but it will be understood that they may be configured similarly as described with reference to FIGS. 1 and 2. Moreover, computing device 400 may be configured to perform method 300 of FIG. 3 in exemplary aspects. For example, compression and packetization block 166 may be configured according to FIG. 2 and comprise P-Header generator 208 to generate P-Headers according to exemplary aspects described previously.

Computing device 400 may also include memory 410, with processor 70 communicatively coupled to memory 410. Computing device 400 may also include display 428 and display controller 426, with display controller 426 coupled to processor 70 and to display 428.

In some aspects, computing device 400 of FIG. 4 may include some optional blocks showed with dashed lines. For example, computing device 400 may optionally include coder/decoder (CODEC) 434 (e.g., an audio and/or voice CODEC) coupled to processor 70; speaker 436 and microphone 438 coupled to CODEC 434; and wireless controller 440 (which may include a modem) coupled to wireless antenna 442 and to processor 70.

In a particular aspect, where one or more of these optional blocks are present, processor 70, display controller 426, memory 410, CODEC 434, wireless controller 440, as well ETM 162 and trace repository 170 mentioned above, can be included in a system-in-package or system-on-chip device 422. Input device 430, power supply 444, display 428, speaker 436, microphone 438, wireless antenna 442, and debug host 82 may be external to system-on-chip device 422 and may be coupled to a component of system-on-chip device 422, such as an interface or a controller.

It should be noted that although FIG. 4 depicts a computing device (which may be used for wireless communications in some aspects, as noted above), processor 70 and memory 410 may also be integrated into a set top box, a music player, a video player, an entertainment unit, a navigation device, a personal digital assistant (PDA), a fixed location data unit, a computer, a laptop, a tablet, a communications device, a mobile phone, or other similar devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer readable media embodying a method for instruction tracing as described herein. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method of instruction tracing, the method comprising:
generating packets comprising trace information for load/store instructions executed in a processor; and
generating a P-Header comprising commit information for load/store instructions of a maximum number of two or more packets, if none of the load/store instructions in the maximum number of two or more packets were killed.

2. The method of claim 1, further comprising placing the P-Header packet immediately after a sequence of the maximum number of two or more packets in an instruction trace, if none of the load/store instructions in the maximum number of two or more packets were killed.

3. The method of claim 2, further comprising providing the instruction trace to an external trace analyzer or decompressor for reconstructing an instruction execution sequence.

4. The method of claim 1, comprising receiving a kill indication that a load/store instruction in a first packet was killed and generating a P-Header immediately following the first packet.

5. The method of claim 4, further comprising placing the P-Header immediately after the first packet in an instruction trace.

6. The method of claim 1, wherein the maximum number is 18.

7. The method of claim 1, wherein the packets comprise at least one of an E-type packet or an N-type packet, wherein an E-type packet comprises a branch instruction which was taken and an N-type packet comprises a branch instruction which was not-taken.

8. The method of claim 1, wherein the instruction tracing is performed in an Embedded Trace Macrocell (ETM).

9. An apparatus comprising:
a packet generator configured to generate packets comprising trace information for load/store instructions executed in a processor; and
a P-Header generator configured to generate a P-Header comprising commit information for load/store instructions of a maximum number of two or more packets, if none of the load/store instructions in the maximum number of two or more packets were killed.

10. The apparatus of claim 9, wherein the P-Header generator is configured to place the P-Header packet immediately after a sequence of the maximum number of two or more packets in an instruction trace, if none of the load/store instructions in the maximum number of two or more packets were killed.

11. The apparatus of claim 9, further comprising an external trace analyzer or decompressor configured to receive the instruction trace and reconstruct an instruction execution sequence.

12. The apparatus of claim 9, wherein the P-Header generator is configured to receive a kill indication that a load/store instruction in a first packet was killed and generate a P-Header immediately after the first packet.

13. The apparatus of claim 12, wherein the P-Header generator is configured to place the P-Header immediately after the first packet in an instruction trace.

14. The apparatus of claim 9, wherein the maximum number is 18.

15. The apparatus of claim 9, wherein the packets comprise at least one of an E-type packet or an N-type packet, wherein an E-type packet comprises a branch instruction which was taken and an N-type packet comprises a branch instruction which was not-taken.

16. The apparatus of claim 9, comprising an Embedded Trace Macrocell (ETM) configured to trace the instructions.

17. The apparatus of claim 9, integrated into a device, selected from the group consisting of a set top box, a music player, a video player, an entertainment unit, a navigation device, a personal digital assistant (PDA), a fixed location data unit, a computer, a laptop, a tablet, a communications device, and a mobile phone.

18. An apparatus comprising:
means for generating packets comprising trace information for load/store instructions executed in a processor; and
means for generating a P-Header comprising commit information for load/store instructions of a maximum number of two or more packets if none of the load/store instructions in the maximum number of two or more packets were killed.

19. The apparatus of claim 18, further comprising means for placing the P-Header packet immediately after a sequence of the maximum number of two or more packets in an instruction trace if none of the load/store instructions in the maximum number of two or more packets were killed.

20. The apparatus of claim 18, further comprising means for receiving the instruction trace and reconstructing an instruction execution sequence.

21. The apparatus of claim 18, further comprising means for receiving a kill indication that a load/store instruction in a first packet was killed and means for generating a P-Header immediately after the first packet.

22. The apparatus of claim 21, further comprising means for placing the P-Header immediately after the first packet in an instruction trace.
